(19) United States
(12) Patent Application Publication
(10) Pub. No.: US 2025/0284686 A1
(43) Pub. Date: Sep. 11, 2025

(54) SPECULATIVE EXECUTION USING PREDICTED RESPONSES AND DISTRIBUTED CANCEL

(71) Applicant: International Business Machines Corporation, Armonk, NY (US)

(72) Inventors: Kavya Govindarajan, Chennai (IN); Chander Govindarajan, Chennai (IN); Priyanka Prakash Naik, Mumbai (IN); Seep Goel, Bengaluru (IN)

(21) Appl. No.: 18/595,632

(22) Filed: Mar. 5, 2024

(51) Int. Cl. G06F 16/2453

(52) U.S. Cl. CPC G06F 16/24539

(57) ABSTRACT

Speculative execution and propagated cancel provide an early response prediction at sender microservices, allowing the services to speculatively continue execution and return tentative responses. Identified frequent requests to certain microservices are periodically submitted for response regardless of need for immediate request execution. Change propagation ensures frequently requested information is updated in response caches at the sender side for generating predicted responses.

### BACKGROUND

The present invention relates generally to the field of computer networking, and more particularly to query response latency across multiple distributed computing environments.

It is known to cache responses to queries via a normal caching process. In such a system, the new query must match the stored query for the corresponding stored response to be returned to the requester. If no match is available, the query must be processed without benefit of the cached query/response pairs.

Branch prediction is a technique to predict the outcome of a conditional operation. It is practiced by modern CPUs, which contain a dedicated hardware unit called a branch prediction unit (BPU). The BPU predicts which branch will be chosen with high confidence given the current encoded instruction. It operates with known values, making “true/false” decisions.

A monolithic application is built as a single unified unit, while a microservices architecture is a collection of smaller, independently deployable services. Services are often made available within a microservices architecture rather than as monolithic applications.

In cloud computing, a cloud is a collection of servers that cloud customers access over the Internet. Typically, each cloud is managed by a cloud provider, which is a company that offers cloud services. A public cloud is a cloud network shared by multiple enterprises. The term “Multi-cloud” suggests the use of multiple public clouds. Instead of an enterprise using one cloud provider for cloud hosting, storage, and the full application stack, in a multi-cloud configuration the enterprise may use multiple cloud providers. In addition to using multi-cloud environments, enterprises often rely on edge networks for latency-important applications.

Sidecar containers are the secondary containers that run along with the main application container within the same microservices pod, such as in a Kubernetes Pod. These containers are used to enhance or to extend the functionality of the main application container by providing additional services, or functionality such as logging, monitoring, security, or data synchronization, without directly altering the primary application code.

### SUMMARY

In one aspect of the present invention, a method, a computer program product, and a system includes: identifying a first microservice having intermediate information needed to create a final response to a request for information; sending an intermediate request for the intermediate information to the first microservice; determining a delay in receiving the intermediate information from the first microservice; generating a predicted response from the first microservice, the predicted response including predicted intermediate information; applying the predicted intermediate information to a response process for determining the final response; receiving an actual response from the first microservice, the actual response including actual intermediate information; and taking a responsive action based on a comparison of the actual intermediate information and the predicted intermediate information.

Another aspect of the present invention may include determining, based on the comparison, the actual intermediate information is a mismatch with respect to the predicted intermediate information. Taking the responsive action includes rolling back the response process to apply the actual intermediate response.

In another aspect of the present invention, a method, a computer program product, and a system includes: identifying a frequent request sent from a set of applications to a target microservice, the frequent request meeting a threshold number of times the frequent request was send to the target microservice; automatically sending the frequent request at pre-defined periods to the target microservice; determining an actual response to the frequent request does not match a stored response to the frequent request, the stored response being stored in a response cache of an application of the set of applications; and updating the response cache and other response caches of the set of applications to replace the stored response with the actual response.

### BRIEF DESCRIPTION OF THE SEVERAL VIEWS OF THE DRAWINGS

FIG. 1 is a schematic view of a first embodiment of a system according to the present invention;

FIG. 2 is a first flowchart showing a method performed, at least in part, by the first embodiment system;

FIG. 3 is a second flowchart showing a method performed, at least in part, by the first embodiment system;

FIG. 4 is a schematic view of a machine logic (for example, software) portion of the first embodiment system;

FIG. 5 is a schematic view of a second embodiment of a system according to the present invention;

FIG. 6 is a schematic view of a third embodiment of a system according to the present invention; and

FIG. 7 is a schematic view of a fourth embodiment of a system according to the present invention.

### DETAILED DESCRIPTION

Speculative execution and propagated cancel provide an early response prediction at sender microservices, allowing the services to speculatively continue execution and return tentative responses. Identified frequent requests to certain microservices are periodically submitted for response regardless of need for immediate request execution. Change propagation ensures frequently requested information is updated in response caches at the sender side for generating predicted responses. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not storage in the form of one or more transitory signals, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Microservices are an architectural and organizational approach to software development where software is composed of small independent services that communicate over well-defined application programming interfaces (APIs). Microservices architectures make applications easier to scale and faster to develop, enabling innovation and accelerating time-to-market for new features. A monolithic approach runs all components or processes are as a single service. Whereas, with microservices architecture, applications are built as various independent components that run as a process as a service in a distributed computing environment. Microservices communicate with one another and other programs via APIs. Because microservices are independent in operation and execution, each service can be updated, deployed, and scaled to meet demand for specific functions.

Computing environment 100 contains an example of an environment for the execution of at least some of the computer code involved in performing the inventive methods, such as return value manager 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

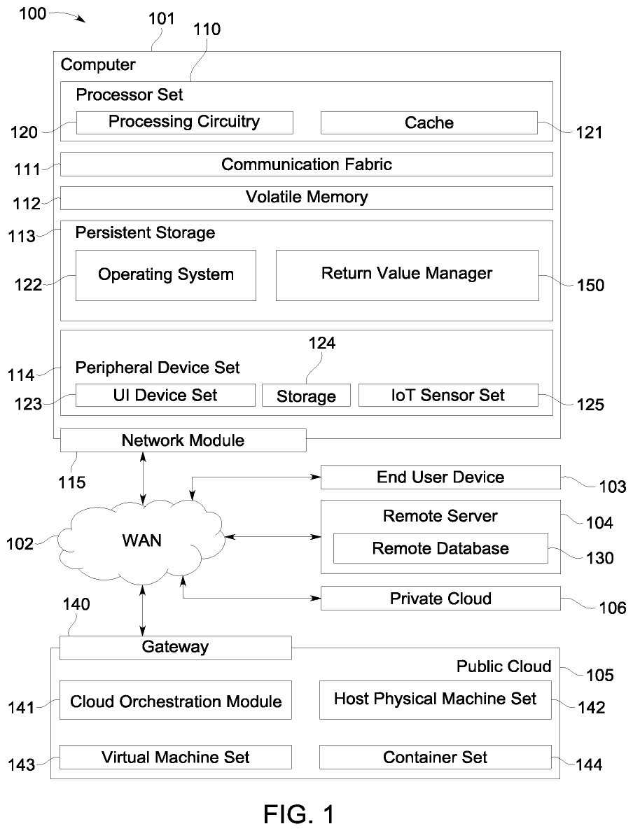

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 represents the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Return value manager 150 operates to process requests for information within distributed computing environments, including, for example, multi-cloud and edge cloud microservices, using predicted intermediate responses for speculative execution of the response. Predicted intermediate responses are maintained for future use. During speculative execution, a rollback process and distributed cancel ensure correct intermediate responses are used, even when the predicted intermediate response is not a correct response. Changes to predicted responses are propagated within the system. Frequently requested intermediate responses stored in the system are periodically update by automatic periodic requests to the relevant service.

Some embodiments of the present invention are directed to an architecture where applications include a sidecar container on one or both sides, the sender side and receiver side, of a query response process. The disclosed functionality works for any directed acrylic graph (DAG), including microservices. Some embodiments of the present invention address a problem where a user request times out waiting for an intermediate response from a receiver-side microservice when subsequent processing by the sender-side microservice may not require an exact value from the receiver microservice, but an approximate or historically accurate response may be sufficient to proceed. The sidecar container operates to predict a delayed response in order to move the response processing forward via speculative execution, using the predicted response. When a sidecar container is used in this way, the response predictor operates as an intermediary, requesting a response from the target microservice and generating a predicted response, which is returned to the requesting, or sending, microservice.

Some embodiments of the present invention recognize the following facts, potential problems and/or potential areas for improvement with respect to the current state of the art: (i) with the microservices and multi-cloud deployment trend, the end-user latency for requests is greatly affected since requests could involve internal calls and/or requests spanning across microservices, which could be deployed across clouds; (ii) conventional cancellation handles a single application and a corresponding cancel strategy, rather than a chain of cancellations associated with a process, such as a multi-cloud process, that may involve edge networks; and (iii) latency may increase when operating in multi-cloud configurations in a microservices architecture.

Some embodiments of the present invention are directed to change propagation where frequently requested values are updated by periodic automatic queries. In this example, the response predictor sidecar sends the periodic automatic queries. Alternatively, a return value manager causes the sender microservice to periodically submit queries related to frequently requested values. When a returned value changes for a frequently requested value, updates are made to any caches in which stored query responses are maintained. The stored query responses may be stored at the sender microservice or the receiver microservice. Alternatively, the return value manager stores the query responses local to the return value manager.

According to some embodiments of the present invention, the propagated cancel process is directed by a response validator, which is an equality function or user-defined equality function. When the predicted response does not meet the equality function of the response validator, a distributed cancel is initiated in which a roll back of the current services is performed returning the query response process to a safe checkpoint. In this example, the safe checkpoint is a most recent response that does not rely upon the incorrectly predicted response. Further, the response validator may message the receiver side service managers to rollback the state and may send a negative request where speculative responses are involved.

Some embodiments of the present invention are directed to a response predictor that predicts receiver microservice response at the sender side whenever an intermediate request is sent. Predicting a response at the sender side operates to reduce communication overhead. In this example, the response predictor identifies a predicted response from a response cache by matching request parameters. The state and execution of the requests are stored in a speculative cache when speculation is permitted, or turned on, for a given microservice receiving a request.

Some embodiments of the present invention are directed to a distributed cancel process that rolls back execution of a request across microservices when an actual response differs from an earlier-used predicted response. The process of distributed cancel is performed by revisiting the corresponding speculative cache of the response predictor and rolls back the operations. Further, the distributed cancel is triggered for other communicating microservices operating on the current query to roll back the speculative or predicted responses and subsequent operations using those erroneously predicted values. According to some embodiments of the present invention, the distributed cancel is a process triggered upon a determination that a predicted response value is not equal to the actual response. Alternatively, the distributed cancel process is triggered upon a determination that a predicted response value does not sufficiently match the actual response according to an equality function comparing the two values.

Some embodiments of the present invention are directed to change propagation responsive to a predicted response value of a frequent request changing from what is stored in a cache of predicted responses. The change propagation process reduces mis-speculation by keeping a corresponding response predictor up to date with the data from the target application, or microservice. According to some embodiments of the present invention, the change propagation process periodically polls certain microservices with frequently received requests. The response predictors are updated according to the latest responses to the frequently received requests when the cached responses change.

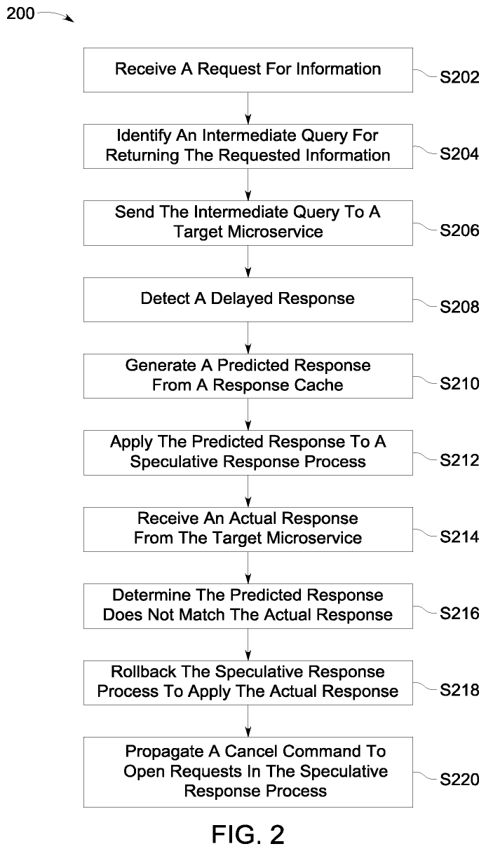

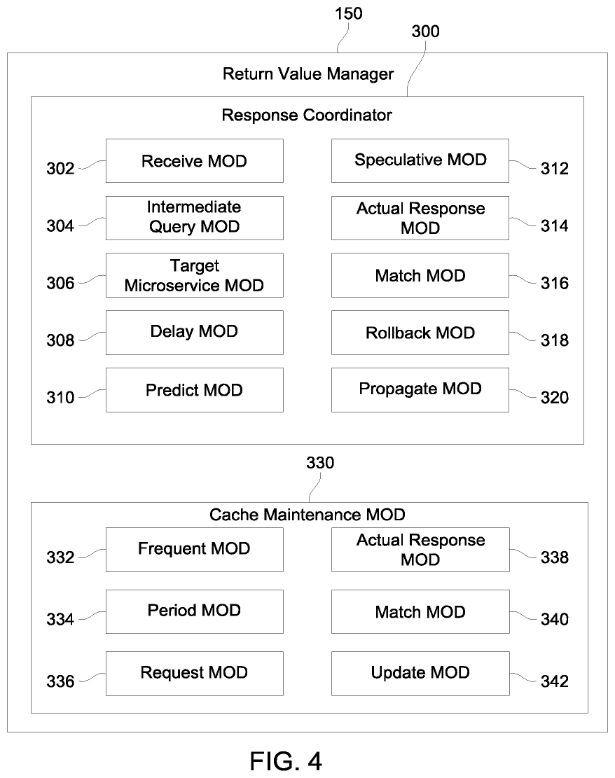

FIG. 2 shows flowchart 200 depicting a first method according to the present invention. FIG. 4 shows program 150 for performing at least some of the method steps of flowchart 200. This method and associated software will now be discussed, over the course of the following paragraphs, with extensive reference to FIG. 2 (for the method step blocks) and FIG. 4 (for the software blocks).

Processing begins are step S202, where receive module (“mod”) 302 receives a request for information. Examples of requests for information include an application for flight booking that receives a user query for available flights, an accounting application receiving requests for billing or invoice information, and a taxi service application receiving a request for available ground transportation.

Processing proceeds to step S204, where intermediate query mod 304 identifies an intermediate query for returning the requested information. Oftentimes, in a distributed computing environment, various microservices may have access to pieces of information needed to respond to a received request for information. For example, a request for available flights may require contacting one microservice for availability of flights and another microservice for individual flight details of the available flights. In this example, the intermediate query mod determines what intermediate queries are to be sent to which microservices for generating a response with the requested information.

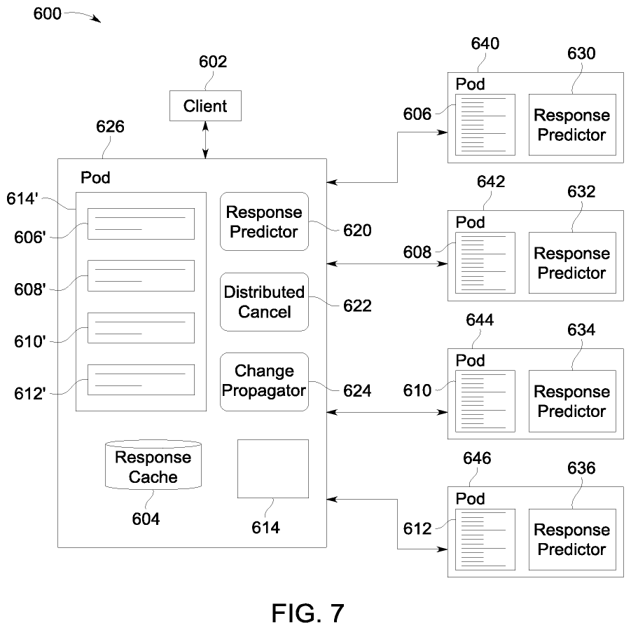

Processing proceeds to step S206, where target microservice mod 306 sends an intermediate query to a target microservice. In practice, there may be several intermediate queries to generate response to the request. FIG. 7 illustrates a process for generating response 614, where four microservices contribute needed information 606, 608, 610, and 612. In this example, microservice A sends an intermediate query to microservice B, the target microservice. With reference to computing environment 100, the request for information may come from end user device 103 to microservices A and B in public cloud 105. Alternatively, microservice A may be located remote server 104 and microservice B may be in private cloud 106.

Processing proceeds to step S208, where delay mod 308 detects a delayed response. In this example, the delay mod waits a defined period of time, which triggers a delayed response detection. Alternatively, the detected delay may be based on historic access to the target microservice, such that the target microservice is presumed delayed upon being identified as the target microservice. Alternatively, a delayed communications receipt prompts a detection of the delayed response. Regardless of how the delay is detected, up detecting a delay, processing proceeds to step S210.

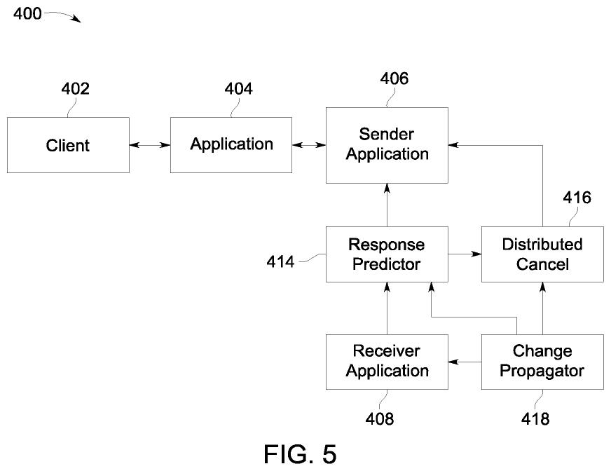

Processing proceeds to step S210, where predict mod 310 generates a predicted response from a response cache. In this example, upon meeting the threshold period of time, the predict mod access the response cache for determining a predicted response to the query. Alternatively, when the target microservice is presumed to delay the response, the intermediate query is sent in parallel with the predict mod generating the predicted response. By predicting the response when a delayed response is detected, processing may proceed using the predicted response while awaiting the actual response to be received from the target microservice. According to some embodiments of the present invention a response predictor, such as response predictor module 414 (FIG. 5), predicts a tentative response and sends the intermediate query to the target microservice, such as receiver application 408.

Processing proceeds with step S212, where speculate mod 312 applies the predicted response to a speculative response process. When a predicted response is needed to proceed with processing in a timely manner, the response process operates speculatively. According to some embodiments of the present invention, the speculative process may be rolled back if the predicted response does not match the actual response, received later from the target microservice. Further, embodiments of the present invention may perform a propagated cancel and/or a propagated change throughout the processing environment.

When the predicted response is used for speculative processing, there may be further intermediate responses that also meet a timeliness threshold for further predicted responses. For illustration purposes, this example only operates with one predicted response and a subsequent actual response. Some embodiments of the present invention are scalable such that multiple intermediate queries are used in processing a response to a request for information. According to some embodiments of the present invention, the request for information may include authorization for returning a speculative response or otherwise be submitted such that a speculative response may be returned. Additionally, the request may indicate that a final response may be returned following the speculative response. In that way, if the predicted response is determined not to match the actual response, a later final response serves to update and/or replace the returned speculative response.

Processing proceeds to step S214, where actual response mod 314 receives an actual response from the target microservice. In this example, microservice B responds to the response coordinator 300 with an actual response. As discussed above, a speculative response to the request for information may be completed and returned responsive to the request received in step S202 before the actual response is received. Also, the speculative response process may be ongoing at the time the actual response is received. In some embodiments of the present invention, the response is held until an actual response is received and considered.

Processing proceeds to step S216, where match mod 316 determines the predicted response does not match the actual response. In this example, the speculative response process is ongoing when the mismatch is determined. Matching of the response may be performed by exact match of values. In that way, any variation from the value of the predicted response results in a mismatch being determined. Alternatively, the matching is performed according to an equality function or algorithm in which a variation from an exact match is permitted by use of percentage difference, permissible variation range, or other similarity metric. When the predicted response is determined to match, the speculative process proceeds to generate a final response to the request for information.

Processing proceeds to step S218, where rollback mod 318 rolls back the speculative response process to apply the actual response. During speculative execution, a rollback process and distributed cancel ensure correct intermediate responses are used, even when the predicted intermediate response is not a correct response. The rollback mod returns the query response process to a safe checkpoint, which is a most recent response that does not rely upon the incorrectly predicted response. When a mismatch is determined, the state of each affected microservice is rolled back.

According to some embodiments of the present invention, when the predicted response does not match the actual response, a distributed cancel module such as distributed cancel module 416 (FIG. 5), rolls back the system to a correct state. The rollback action prompts a change propagator, such as change propagator 418 (FIG. 5), to propagate the detected change in response throughout the system for use in future predictions. Further, the response validator may message the receiver side service managers to roll back the state and may send a negative request where speculative responses are involved.

Processing ends at step S220, where propagate mod 320 propagates a cancel command to open requests or calls in the speculative response process. Propagated cancel should be recursively applied further down the chain. For example, if microservice A has called microservice C, then a cancel request should be sent to microservice C when the actual response from microservice B is determined to not match the predicted response. Further, for state modifying requests, a negative request may be sent to the affected microservice, for example, an original create request may be followed by the negative request, to delete.

Some embodiments of the present invention are directed to preventing a complete failure to respond when a microservice member of a response chain fails to respond. For a given microservice pair, A and B, if the receiving Microservice B fails to respond, an actual response will not be returned to sending Microservice A. By having a response predictor at the sender side, Microservice A, a query response may be returned as a tentative, or speculative, response. According to some embodiments of the present invention, the tentative response is returned without explanation as an actual response. Alternatively, the tentative response is returned with a notice that the response is based on a predicted intermediate response from failed Microservice B and is, therefore, a speculative response until further notice or until reasserting the query.

For example, for a given microservices architecture where Microservice A communicates first with Microservice B and then with Microservice C to return a final response to a query. Microservice C is on an edge network and Microservice B is on a central cloud network, different than the cloud network on which Microservice A runs. Accordingly, the communication overhead between A and B is relatively high. When Microservice A receives the query, request predictor A (the sidecar predictor for Microservice A) uses a stored intermediate response from Microservice B to speculate the response from Microservice B. The request predictor A stores the predicted response in a speculative cache. The predicted response is used to trigger a response from Microservice C. Microservice A returns a tentative response to the query to the requestor along with a speculative tag. When Microservice B responds with an actual response matching the predicted response, the speculative cache for responding to the query is removed. When the actual response does not match the predicted response, a distributed cancel is trigger on Microservice A and on Microservice C. When Microservice B fails to respond with an actual response due a timeout condition, Microservice A resends the tentative response to the query without the speculative tag.

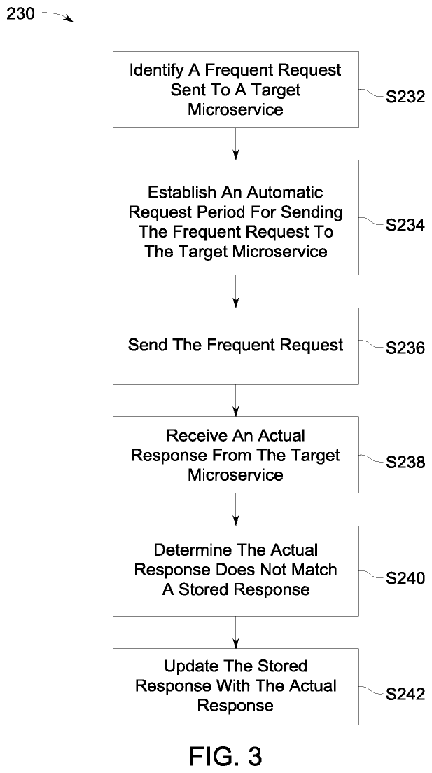

FIG. 3 shows flowchart 230 depicting a first method according to the present invention. FIG. 4 shows program 150 for performing at least some of the method steps of flowchart 230. This method and associated software will now be discussed, over the course of the following paragraphs, with extensive reference to FIG. 3 (for the method step blocks) and FIG. 4 (for the software blocks).

Processing begins are step S232, where frequent module (“mod”) 332 of cache maintenance mod 330 identifies a frequent request sent to a target microservice. In this example, frequent requests sent to a target microservice are identified with reference to historic access to the predicted response cache. When predicted responses are frequently needed, the frequent mod identifies the frequent request, or query, and the corresponding microservice. In this example, a threshold frequency is established for identifying a frequent request.

Processing proceeds to step S234, where period mod 334 establishes an automatic request period for sending the frequent request to the target microservice. In this example, when a threshold frequency of the same request is received from a set of sending microservices, the corresponding target microservice is polled with the request periodically to maintain an updated cache of the predicted response. In this way, the period module establishes and automatic speculative polling process.

Processing proceeds to step S236, where request mod 336 sends the frequent request to the corresponding microservice. In this example, the sending of the identified frequent request is performed according to the automatic request period established in step S234. Alternatively, a standard automatic period is established for any identified frequent request. According to some embodiments of the present invention, the automatic request period is established by definition upon receipt of a given request designated as being a frequent request.

Processing proceeds to step S238, where actual response mod 338 receives an actual response from the target microservice. In this example, the request is sent by automatic request for the purpose of determining if the actual response differs from the stored response. Accordingly, the actual response mod awaits the response rather than monitor for delay in a process where a predicted response is generated. According to some embodiments of the present invention, upon sending the frequent request, the actual response mod generates a predicted response for comparison upon receipt of the actual response.

Processing proceeds to step S240, where match mod 340, determines the actual response does not match a stored response. In this example, the actual response mod provides the actual response to match mod, where the actual response is compared to a stored response. Alternatively, the actual response mod provides both the generated predicted response and the actual response for determining a match. When a change in the value of the stored response is identified, cache maintenance mod 330 updates the cached predicted response. According to some embodiments of the present invention, a determination of a sufficient change drives the process of updating the cached responses. Sufficient change may be defined by an equality function. The equality function may define a threshold difference in value or percentage difference in value such that a sufficient change exists to prompt an update to the cached predicted response.

Processing ends at step S242, where update mod 342 updates the stored response with the actual response. Change propagation operates to reduce error propagation by maintaining correct response predictors. In some embodiments of the present invention, the cache maintenance mod sits at the receiver-side microservice and speculatively polls and/or self-calls using frequently received requests sent from other microservices. The update module updates the response predictor on all sender microservices with a current response value.

Further embodiments of the present invention are discussed with reference to FIGS. 5-7 and in the paragraphs that follow.

FIG. 5 shows speculative processing system 400 depicting system components according to an embodiment of the present invention. Speculative processing system 400 includes: client device 402; requesting application 404; sender application 406; receiver application 408; response predictor module 414; distributed cancel module 416; and change propagator module 418. Speculative processing system 400 may be controlled, at least in part, by return value manager 150 (FIG. 1).

Some embodiments of the present invention are directed to a system including a change propagator module for managing changes to historic values used for speculative execution of queries. With reference to FIG. 5, change propagator 418 may sit near each receiver microservice, such as receiver application 408, as a sidecar. The sidecar change propagator may be co-located with a response predictor module 414. The change propagator may track frequent requests received from sending microservices, such as sender application 406.

The tracker may be programmed such that for a given receiver microservice, M, take a set of microservices, S, making frequent calls, or requests, R. According to some embodiments of the present invention, the change propagator module periodically queries the receiver microservice, M, with the frequent requests, R. So long as there is no change in value of the requested parameter, no action is taken. However, when a change in value is detected, the change propagator causes the detected change in value to propagate to the set of microservices, S, making frequent calls, R. In that way the response predictors of the set of microservices receives the updated value for use in predicting responses to future requests, R.

Some embodiments of the present invention speculate on the usefulness of the frequent requests. If none of the frequently querying microservices use the corresponding parameter value, the request is deemed not useful. For example, the usefulness evaluation may determine that the sending microservice only uses the parameter value as a predicted response once for every five requests sent to the receiving microservice.

Some embodiments of the present invention are directed to recursive speculative execution where the speculative response provided by the response prediction module is used as input to the query response process so that execution may proceed, though speculatively. Speculative execution may occur recursively.

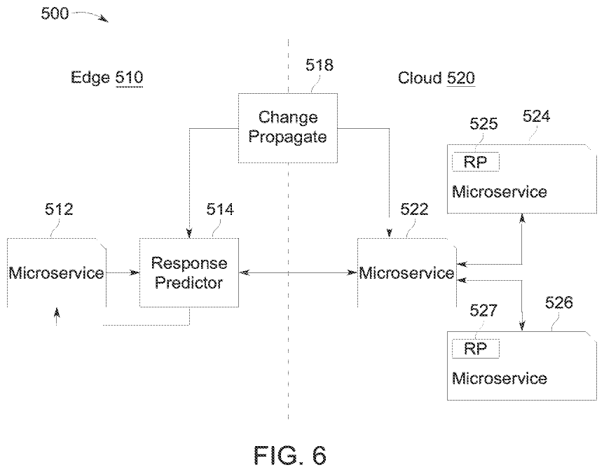

FIG. 6 is an example embodiment of process 500 including recursive execution for response to a request. Process 500 may be performed, at least in part, by speculative processing system 400. Process 500 includes components in edge network 510 and component in cloud environment 520. In this example process, microservice 512 calls microservice 522. The microservice 522 then calls microservice 524 and microservice 526 for recursive execution to receive responsive data for returning a response to the microservice 512. In that way, each microservice, 522, 524, and/or 526, can speculatively execute on predicted responses and return a tentative response to microservice 512, in latency in edge network 510 is carefully avoided. When microservice 512 submits a request, local response predictor 514 determines whether or not to return a tentative response. When a tentative response is available, local response predictor 514 returns the tentative response and requests actual responses from the corresponding microservice, such as microservice 522. Microservice 522 awaits actual responses from microservice 524 and/or microservice 526 to generate a final response to return to microservice 512. Some embodiments of the present invention provide for the end application to return intermediate tentative responses back to the requesting service or response predictor. Receiving a tentative response may be established by client preference.

Alternatively, microservice 524 includes sidecar response predictor 525 and microservice 526 includes sidecar response predictor 527 such that predicted response originate at the receiving microservice when further latency may be associated with an intermediate response. Further, progress toward a final response may be presented to the user via a user interface. Alternatively, the tentative response is provided as an estimate. The response may indicate what responsive values are predicted in support of the estimate. When actual responses are received from microservices whose responses were predicted, response predictor 514 may determine a mismatch in predicted response compared to actual response. When a mismatch occurs, change propagator 518 initiates a change to stored data used to predict responses. According to some embodiments of the present invention, change propagator updates response caches stored throughout the system, whether in a cloud environment or an edge network.

Some embodiments of the present invention are directed to a propagated cancel process where the actual response is received and is different than the predicted value. The difference may be based on a threshold level of differentiation defined by an equality function. The use of propagated cancel on intermediate requests prevents unnecessary execution. It should be understood that the propagated cancel is not always needed, for example, GET requests are idempotent in that the value of the response is unchanged when multiplied or otherwise operated on by itself.

The propagated cancel process may trigger cancel on all speculatively called microservices. The cached values may be used in execution until a request to check whether stored values change or not. When a change is determined, the state of each affected microservice should be rolled back. Propagated cancel should be recursively applied further down the chain. For example, if microservice 522 has called microservice 524, then a cancel request should be sent to microservice 524. Further, for state modifying requests, a negative request may be sent to the affected microservice, for example, an original create request may be followed by the negative request, to delete.

Some embodiments of the present invention are directed to making a query response decision based on conditions related to the communication overhead for receiving an actual response from a given microservice. For example, when Microservice 512 needs to send a request to a receiving Microservice 522, a response predictor may refer to a compute time record to determine that response speculation is appropriate. In this example, the response predictor module periodically records the communication overhead between Microservice 512 and Microservice 522 and the compute time of the various microservices. When the compute time for Microservice 512 is relatively high and the communication overhead between Microservices 512 and Microservice 522 is low, response speculation is turned off. When the compute time for Microservice 522 is relatively high and communication overhead is low, response speculation is turned on. Finally, when the communication overhead relatively high and the compute overhead for Microservices 512 and/or Microservice 522 is either low or high, the response speculation is turned on.

Some embodiments of the present invention are directed toward synchronous and blocking calls, where microservices requests are being sent across cloud networks, to improve latency in returning a query response. Improved latency may be achieved by use of a “response prediction” and “speculative execution” at sender microservices side. Such arrangement addresses both communications latency between microservices and receiver microservice computation latency. An example process is where a first thread of Microservice 522 awaits an actual response from Microservice 524 after sending Microservice 524 a request. response predictor module 525 predicts a response for the request sent to Microservice 524, the response predictor module operating as a sidecar application of Microservice 524. Microservice 522 proceeds with execution of the query response using the generated response, a predicted response, without blocking progress of the thread. Alternatively, the response predictor module operates as a sidecar application to microservice 522, predicting the response from microservice 524.

As illustrated in FIG. 7, a client 602 may submit a request requiring intermediate responses 606, 608, 610, 612 from multiple services 640, 642, 644, 646 to return a complete response 614 to the client. Response system 600 is an example environment for execution of at least some of the computer code involved in performing inventive methods disclosed herein, such as primary response pod 626. In addition to block 626, system 600 includes, for example, the sidecar applications response predictor module 620, propagated cancel module 622, and change propagator module 624 and response cache 604. The system 600 further includes microservices pods 640, 642, 644, and 646, and sidecar response predictors 630, 632, 634, and 636.

Conventional processing may hold the process for response 606, when response 608 does not depend on response 606 itself, rather, an approximate value of response 606 may be used to produce intermediate response 608. Some embodiments of the present invention provide for response predictor 620, local to primary response pod 626, to generate predicted response 606′ representing actual response 606 in order to proceed with speculative processing of intermediate response 608′. Alternatively, sidecar response predictor 630 generates predicted response 606′, the response predictor 630 being local to the microservices pod 640. In this example, subsequent responses rely upon speculative responses 606′ and/or 608′ to return tentative response 614′ to the client. In this example, predicted intermediate responses are tracked such that when a corresponding actual response is received. For example, primary response predictor 620 compares actual value 608 to predicted value 608′. When a mismatch in values is identified by response predictor 620, propagated cancel module 622 initiates a corrective action to cancel the use of the incorrectly predicted values including, for example, a rollback process. Where appropriate, change propagator module 624 updates the cached response values throughout the system to match the update value.

According to some embodiments of the present invention, the client indicates that a tentative response may be returned. In such cases, the primary response pod 626 returns speculative response 614′ with a tag indicating the response is tentative. Further, if primary response pod 626 returns actual response 614, the tag indicates the response is final.

Some embodiments of the present invention are directed to response prediction, by for example response predictor 620, and speculative execution using predicted responses. Response prediction serves to predict responses using cached prior responses to queries or using machine learning algorithms for predicting a response based on learned responses. Some systems will return a predicted response to the requester and sends the original request to a receiving microservice pod for processing.

Some embodiments of the present invention are directed to speculative execution. The response process continues execution speculatively using the predicted response received from one or more microservices pods on which the query depends, such as microservices pods 606, 608, 610, and 612, while awaiting an actual response from the dependent microservices. If the predicted response is the same response received from the receiving service, execution continues. If the predicted response is different than the response received from the receiving service, a propagated cancel module initiates a propagated cancel throughout the system. When the speculative response is completed for return to requester, intermediate responses may be unresolved predicted responses. In such case, some embodiments of the present invention transmit a tentative response to the requester. The tentative response may be flagged as tentative. A tentative response may be provided with identification of the unresolved predicted response.

Propagated cancel serves to roll back the speculative response to a last correct state, effectively replacing an erroneous predicted response with the correct response. A change propagator, such as change propagator 624, keeps up-stream response predictors up to date for common requests.

Some embodiments of the present invention are directed to preventing a complete failure to respond when a microservice member of a response chain fails to respond. For a given microservice pair, A and B, if the receiving Microservice B fails to respond, an actual response will not be returned to sending Microservice A. By having a response predictor at the sender side, Microservice A, a query response may be returned as a tentative, or speculative, response. According to some embodiments of the present invention, the tentative response is returned without explanation as an actual response. Alternatively, the tentative response is returned with a notice that the response is based on a predicted intermediate response from failed Microservice B and is, therefore, a speculative response until further notice or until reasserting the query.

For example, for a given microservices architecture where Microservice A communicates first with Microservice B and then with Microservice C to return a final response to a query. Microservice C is on an edge network and Microservice B is on a central cloud network, different than the cloud network on which Microservice A runs. Accordingly, the communication overhead between A and B is relatively high. When Microservice A receives the query, request predictor A (the sidecar predictor for Microservice A) uses a stored intermediate response from Microservice B to speculate the response from Microservice B. The request predictor A stores the predicted response in a speculative cache. The predicted response is used to trigger a response from Microservice C. Microservice A returns a tentative response to the query to the requestor along with a speculative tag. When Microservice B responds with an actual response matching the predicted response, the speculative cache for responding to the query is removed. When the actual response does not match the predicted response, a distributed cancel is trigger on Microservice A and on Microservice C. When Microservice B fails to respond with an actual response due a timeout condition, Microservice A resends the tentative response to the query without the speculative tag.

Some embodiments of the present invention are directed to optimizing processes related to flight booking. For example, a user query for available flights from location A to location B may be processed in a conventional computing environment including the microservices “get_available_flights” and “flight_details.” Returning available flights may be subject to increased latency due to the dependency between microservices. If the front end calls a first microservice with the query, the first microservice will call get_available_flights to identify available flights, which may return ten available flights. The first microservice will then call flight_details to obtain details related to the ten available flights. Latency may be introduced by the dependency on get_available_flights providing information prior to calling flight_details with the available flights. This problem of dependency based latency is address by introduction of aspects of the present invention.

According to some embodiments of the present invention, when the front end calls the first microservice, the first microservice is able to both (1) call get_available_flights to identify available flights, and (2) receive a predicted response value of eight flights. The first microservice is able to call flight_details right away with the speculative value of eight flights. By the time get_available_flights returns the correct value of seven, the first microservice already has flight information for the predicted eight flights. The first microservice only needs to return to the front end the information collected for seven of the eight flights. This assumes the predicted speculated set of eight flights includes the seven available flights. Even if flight information for some of the eight flights must be subsequently called for, processing time is reduced by already having information for the speculated set of flights.

According to some embodiments of the present invention, the response prediction module operates to predict a receiver's response at the sender side itself. The response prediction module may use caching or machine learning to predict responses from a receiver based on past request/response cycles. In addition to determining a predicted response, the response predictor may also send a request to the receiver for obtaining an exact current response.

Some embodiments of the present invention are directed to accelerating a response to a query when data input from a receiving microservice are not available. This is achieved by predicting from a response cache, a response that would have likely been returned by the unavailable microservice.

Some embodiments of the present invention are directed to a process for speculative execution and distributed cancel in a microservice infrastructure. The process including one or more of the following operations: (i) deploy a response predictor and change propagator as a sidecar container for necessary applications, including those application located at an edge network; (ii) receive, by a necessary application, a request from a sender microservice; (iii) return a predicted response by a response predictor located as a sidecar to the necessary application; (iv) sending, by the response predictor, the request to the necessary application; (v) record, by a change propagator at the receiver microservice, the received request for determining frequency of request; (v) proceed, by the sending microservice, with speculative execution of the query; (vi) receive, by the response predictor, an actual response from the necessary application; (vii) determine if the predicted response is correct by comparing the predicted response to the actual response; (viii) take a responsive action to ensure the speculative execution uses a correct response, whether using the predicted response or an updated response using the actual response.

Some embodiments of the present invention are directed to deploying a sidecar to target applications for processing predicted responses. The sidecar approach supports agnostic prediction and change propagation in the microservices infrastructure.

Some embodiments of the present invention are directed to requester acknowledgement of the use of tentative responses when responding to a query. When a requester accepts tentative responses, a response based on predicted intermediate responses is returned to the requester before confirming that a predicted response is correct. In some embodiments of the present invention, acknowledgment is indicated by header information submitted with the query. Regardless of accepting tentative responses, speculative execution will proceed. When tentative responses are not accepted, the process confirms each predicted response is correct prior to returning a final response to the query. According to some embodiments of the present invention, a tentative response is followed up with a final response having confirmed correct intermediate responses.

Some embodiments of the present invention are directed to predicting intermediate responses by using parameters provided in the request along with past history of responses to the same request. According to some embodiments of the present invention, the actual response from the target application is received by the response predictor instead of the sender microservice, the response predictor operating as a sidecar to the target application.

Some embodiments of the present invention are directed to speculative polling of certain frequent requests received by a corresponding receiving microservice. When a threshold frequency of the same request is received from a set of sending microservices, the target application is polled with the request periodically to maintain updated the cached predicted response. When a change in the value of the predicted response is identified, the system updates the cached predicted response. According to some embodiments of the present invention, a determination of a sufficient change drives the process of updating the cached responses. Sufficient change may be defined by an equality function. The equality function may define a threshold difference in value or percentage difference in value such that a sufficient change exists to prompt an update to the cached predicted response.

According to some embodiments of the present invention, if a second request needs to be made to a second microservice, the second request can either wait until an actual response is received from the earlier contacted microservice or a second predicted response to the second request can be initiated through sending the second request to the second microservice, also having a sidecar response predictor. When the second predicted response does not match the actual response received from the response predictor of the second microservice, the target application may roll back to moment of sending second request, if the application has rollback support. Alternatively, execution of the query may begin from the first intermediate response, using the actual response of the second microservice. This alternative is particularly relevant when the computation time of the second request is less than the communication time required to propagate a cancel.

Some embodiments of the present invention are directed to using predicted responses from IoT devices, where approximate results are often good enough.

Some embodiments of the present invention are directed to updating a message in place after some responses to the message are received.

Some embodiments of the present invention assume there is application-level support for checkpoint and rollback processing. The support may be a language runtime support for rolling back threads, functions, and/or local stack.

Some embodiments of the present invention operate according to an agreement with a client requester to receive speculative responses that may be currently inaccurate due to lack of actual intermediate response data when creating the speculative response.

Some embodiments of the present invention are directed to early response prediction for microservices. In that way, the machine learning models are not request/response driven.

According to some embodiments of the present invention, the rollback is part of the entire request processing.

Some embodiments of the present invention are directed to a system for speculative execution for micro services where, by doing early response prediction, the response is predicted for a request, such as a HTTP request, made to a microservice. These and other requested processed according to the present invention are referred to herein as requests for information.

Some embodiments of the present invention facilitate speculative execution of an instruction while waiting for a result of a previous instruction using a predicted value of the result of the previous instruction. Thus, allowing cancellation of a next instruction if a previously predicted result is not correct while allowing a mis-predicted signal transmission that can be raised before the result of the previous instruction is available.

Some embodiments of the present invention are directed to branch prediction in which selectively storing a remainder block is based on a predicted outcome of a branch instruction. In that way, efficient handling is possible for branches that are not taken, allowing for a more precise restart of the branch predictor than is conventional, ultimately enhancing instruction execution efficiency.

Some embodiments of the present invention are directed to the prediction of responses to requests to microservices based on past responses and using machine learning.

Some embodiments of the present invention are not directed to hardware level computation speculation, but to software speculation of return value of networked calls.

Some embodiments of the present invention are directed to generating a predicted response to a request for information including: receiving, by a first microservice, a request for a computing service from a client device; identifying, by the first microservice, a second microservice having information needed to produce output responsive to the request; sending, by a sidecar response predictor of the first microservice, a intermediate request for the information to the second microservice; determining, by the sidecar response predictor, a latency in receiving the information from the second microservice; generating, by the sidecar response predictor, a predicted response from the second microservice, the predicted response including the information needed to produce the output; receiving, by the sidecar response predictor, an actual response from the second microservice; comparing, by the sidecar response predictor, the predicted response to the actual response to determine a degree of match between the predicted response to the actual response; responsive to determining the degree of match is below a threshold requirement, replacing the predicted response with the actual response; and returning the output responsive to the request to the client device based on the actual response. Replacing the predicted response includes updating a response cache at the first microservice to include the actual response for future use.

Some embodiments of the present invention are directed to updated response caches in a multiple networks environment for generating a tentative response including: identifying, by a first microservice, a set of requests sent to receiving microservices by a response predictor operating as a sidecar application to the first microservice; determining a frequent request in the set of requests, the frequent request meeting a threshold number times being sent to a corresponding microservice during a specified period of time; responsive to determining the frequent request, periodically sending, by the response predictor, the frequent request to the corresponding microservice; comparing, by the response predictor, an actual response from the corresponding microservice to a predicted response stored in a response cache used by the response predictor for speculative execution; and updating the response cache with the actual response when the actual response meets a threshold difference from the predicted response.

Some embodiments of the present invention may include one, or more, of the following features, characteristics and/or advantages: (i) intelligently predicts receiver response; (ii) enables recursive speculative execution for microservices; (iii) enables recursive propagation of cancel for mis-speculation scenarios; (iv) maintains responses to frequent queries up-to-date at sender side caches; (v) reduces chances of mis-speculation of responses to frequent queries; (vi) significantly boosts microservice communication efficiency; (vii) early response prediction at the sender side to anticipate receiver responses; (viii) recursive speculative execution for microservices; (ix) recursive cancel propagation for managing mis-speculation scenarios; and/or (x) self-requested updates to keep responses up-to-date and reduce the chances of mis-speculation.

Some embodiments of the present invention may include one, or more, of the following features, characteristics and/or advantages: (i) spans request processing across multiple micro services (microservice chain); (ii) reduces the network overhead of communication between micro services on multi and edge clouds by predicting the response of a micro service at the sender itself; (iii) a microservice-centric approach, focusing on request processing across multiple communicating microservices; (iv) ensures a computation is not wasted when a communication channel is down, but a tentative response can be generated; (v) improved design for the multi-cloud computer system; (vi) improved performance of multi-cloud and edge cloud microservices; (vii) saves compute time for frequently requested data; and/or (viii) saves on communication overhead between microservices by predicting responses based on a store a frequently arising responses.

Some embodiments of the present invention are directed toward speculative execution and propagated cancel for early response prediction at sender microservices allowing for speculative continuation of query execution and return of a tentative response. The process may include the operations of: (i) early response prediction at sender side to intelligently predict receiver microservice response; (ii) recursive speculative execution for microservices; (iii) recursive propagation of cancel for mis-speculation scenarios; and (iv) change propagation through self-requesting of frequent requests. According to some embodiments of the present invention, self-requesting includes periodically querying frequent requests (at receiver microservice) to update corresponding sender side response caches to keep responses up-to-date and to reduce potential mis-speculation.

Some embodiments of the present invention are directed toward speculation based on compute vs communication overhead.

Some embodiments of the present invention are directed toward preventing complete chain failure in case of network or microservice failure.

Some embodiments of the present invention are directed to a system including at least one of the following components: (i) a response predictor; and (ii) a distributed cancel module.

Some embodiments of the present invention are directed to a process for a restart rollback when a triggering difference arises between a predicted intermediate response and an actual response from a target microservice.

Some embodiments of the present invention are directed to a speculative execution solution providing for microservices to predict a response to requests sent to other microservices. The microservice speculatively continues execution of the query response process using the predicted response. Where a correct speculation is used, the microservice is able to perform query execution without blocking the thread while awaiting the actual response to be received from the target microservice. Some of the described processes are most suitable for cases where an approximate response or an older state or response is sufficient for reaching an adequate result, such as in operation of IoT devices or message queues.

According to some embodiments of the present invention, a response predictor sits at the sender side and predicts the response to requests being sent to various microservices and immediately returns predicted responses to the sender microservice, which continues executing the query response process speculatively. The response predictor may send the request to the microservice after predicting a response and await an actual response from the microservice. According to some embodiments of the present invention, the predicted response is obtained by input/output pairs stored in a response cache. Alternatively, the predicted response is obtained from a machine learning algorithm drawing from a historic input/output repository.

According to some embodiments of the present invention, distributed cancel operates to roll back execution of a request at a microservice when a predicted response is incorrect. The distributed cancel may further operate to propagate the cancel to downstream microservices which have been invoked. The distributed cancel process is triggered when a non-matching condition exists between the predicted response and the actual response. In some examples, the non-matching condition is determined according to an equality function. Alternatively, exact matching is required to satisfy a matching condition. Alternatively, a threshold difference in response value triggers a non-matching condition. Alternatively, a threshold percentage difference in response value triggers a non-matching condition.

According to some embodiments of the present invention, change propagation operates to reduce error propagation by maintaining correct response predictor(s). In some embodiments of the present invention, the change propagation module sits at the receiver-side microservice and speculatively polls and/or self-calls using frequently received requests sent from other microservices. The change propagation module updates the response predictor on all sender microservices with a current response value. In this example, the change propagation process is triggered when a predicted response is determined not to match the actual response. Alternatively, the change propagation process is triggered periodically for the most frequently made requests to the corresponding receiver microservice.

Some embodiments of the present invention are directed to implementing a speculative execution and propagated cancel, also referred to as a distributed cancel, that provides early response prediction at sender microservices allowing them to speculatively continue execution and return tentative response to predict response of the requests. According to some embodiments of the present invention, the speculative execution and propagated cancel include the following operations: (i) implementing early response prediction at sender side to intelligently predict receiver response; (ii) enabling recursive speculative execution for microservices; (iii) enabling recursive propagation of cancel for mis-speculation scenarios; and (iv) implementing change propagation by self-requesting frequent requests including periodically querying frequent requests at the receiver microservice to update all corresponding sender side caches to keep responses up-to-date and reduce chances of mis-speculation.

Some embodiments of the present invention do more than provide a method for implementing a branch predictor for performing speculative execution and enabling rollback mechanism to previous correct state if predicted outcome turns out to be incorrect. Further, aspects of the present invention provide more than merely a method for enabling steps to correct misprediction by returning a processing unit to a state where the dependent instructions can be re-executed using the actual result value.

Some embodiments of the present invention are directed toward implementing change propagation by self-requesting frequent requests including periodically querying frequent requests at receiver microservice to update all corresponding sender side caches to keep responses up-to-date and reduce chances of mis-speculation.

Some embodiments of the present invention are directed to a computer-implemented method including: identifying a first microservice having intermediate information needed to create a final response to a request for information; sending an intermediate request for the intermediate information to the first microservice; determining a delay in receiving the intermediate information from the first microservice; generating a predicted response from the first microservice, the predicted response including predicted intermediate information; applying the predicted intermediate information to a response process for determining the final response; receiving an actual response from the first microservice, the actual response including actual intermediate information; and taking a responsive action based on a comparison of the actual intermediate information and the predicted intermediate information. Accordingly, continued speculative execution of the request proceeds avoiding the delay and thus improving the response time while ensuring the final response is based on current information.

One aspect of the computer-implemented method disclosed herein may include returning a tentative response to the request for information based on the predicted intermediate information, the returning performed prior to receipt of the actual response. In that way, a response is returned quickly while ensuring the client of the response status.

Another aspect of the computer-implemented method disclosed herein may include determining, based on the comparison, the actual intermediate information is a mismatch with respect to the predicted intermediate information. Taking the responsive action includes rolling back the response process to apply the actual intermediate response. In that way, ongoing speculative execution is performed without a risk of returning a response based on old data.

Yet another aspect of the computer-implemented method disclosed herein may be that the receiving the actual response is performed during the response process, prior to determining the final response. In that way, the response process may be adjusted quickly if necessary.

Still yet another aspect of the computer-implemented method disclosed herein may include determining, based on the comparison, the actual intermediate information is a mismatch with respect to the predicted intermediate information. Taking the responsive action includes performing a distributed cancel to end ongoing processes relying on the predicted intermediate information. In that way, ongoing speculative execution is performed without a risk of returning a response based on old data.

A further aspect of the computer-implemented method disclosed herein may include ranking performance of a set of receiving microservices including the first microservice. Determining the delay may include identifying the first microservice as having a performance ranking below a threshold level. Accordingly, speculation execution may proceed in advance of a waiting period.

A still further aspect of the computer-implemented method disclosed herein may be that determining the delay and generating the predicted response is performed by a sidecar response predictor of an application receiving the request for information. In that way, a containerized system may operate efficiently when communications to remote services are not reliable.

An even further aspect of the computer-implemented method disclosed herein may be that determining the delay and generating the predicted response is performed by a sidecar response predictor of the first microservice. In that way, a containerized system may operate efficiently when a remote service experiences delays.

Still yet a further aspect of the computer-implemented method disclosed herein may include maintaining, by a sidecar change propagator, a response cache containing previous responses from a set of receiving microservices including the first microservice. Generating the predicted response is performed with reference to the response cache. In that way, a containerized system may operate efficiently.

Another aspect of the computer-implemented method disclosed herein may include receiving the request for information from a client device. Accordingly, the response process has a triggering receipt of a request.

Some embodiments of the present invention are directed to a computer-implemented method including: identifying a frequent request sent from a set of applications to a target microservice, the frequent request meeting a threshold number of times the frequent request was send to the target microservice; automatically sending the frequent request at pre-defined periods to the target microservice; determining an actual response to the frequent request does not match a stored response to the frequent request, the stored response being stored in a response cache of an application of the set of applications; and updating the response cache and other response caches of the set of applications to replace the stored response with the actual response.

One aspect of the computer-implemented method disclosed herein may be that identifying the frequent request includes: recording information requests set from the set of applications to a plurality of microservices, including the first microservice, the recording including timestamps and content of requests; determining the frequent request is sent a threshold number of times based on the recording; and establishing the pre-defined periods for automatically sending the frequent request to the target microservice.

Some embodiments of the present invention are directed to a computer system including: a processor set; and a computer readable storage medium. The processor set is structured, located, connected, and/or programmed to run program instructions stored on the computer readable storage medium. The program instructions, when executed by the processor set, cause the processor set to perform a method including identifying a first microservice having intermediate information needed to create a final response to a request for information; sending an intermediate request for the intermediate information to the first microservice; determining a delay in receiving the intermediate information from the first microservice; generating a predicted response from the first microservice, the predicted response including predicted intermediate information; applying the predicted intermediate information to a response process for determining the final response; receiving an actual response from the first microservice, the actual response including actual intermediate information; and taking a responsive action based on a comparison of the actual intermediate information and the predicted intermediate information. Accordingly, continued speculative execution of the request proceeds avoiding the delay and thus improving the response time while ensuring the final response is based on current information.

One aspect of the computer system disclosed herein may include causing the processor set to perform a method comprising returning a tentative response to the request for information based on the predicted intermediate information, the returning performed prior to receipt of the actual response. In that way, a response is returned quickly while ensuring the client of the response status.

Another aspect of the computer system disclosed herein may include causing the processor set to perform a method comprising determining, based on the comparison, the actual intermediate information is a mismatch with respect to the predicted intermediate information. Taking the responsive action includes rolling back the response process to apply the actual intermediate response. In that way, ongoing speculative execution is performed without a risk of returning a response based on old data.

Yet another aspect of the computer system disclosed herein may include causing the processor set to perform a method comprising determining, based on the comparison, the actual intermediate information is a mismatch with respect to the predicted intermediate information. Taking the responsive action includes performing a distributed cancel to end ongoing processes relying on the predicted intermediate information. In that way, ongoing speculative execution is performed without a risk of returning a response based on old data.

Still yet another aspect of the computer system disclosed herein may include causing the processor set to perform a method comprising ranking performance of a set of receiving microservices including the first microservice. Determining the delay may include identifying the first microservice as having a performance ranking below a threshold level. Accordingly, speculation execution may proceed in advance of a waiting period.

A further aspect of the computer system disclosed herein may be that determining the delay and generating the predicted response is performed by a sidecar response predictor of an application receiving the request for information. In that way, a containerized system may operate efficiently when communications to remote services are not reliable.

A still further aspect of the computer system disclosed herein may include causing the processor set to perform a method comprising maintaining, by a sidecar change propagator, a response cache containing previous responses from a set of receiving microservices including the first microservice. Generating the predicted response is performed with reference to the response cache. In that way, a containerized system may operate efficiently.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a first microservice having intermediate information needed to create a final response to a request for information;
sending an intermediate request for the intermediate information to the first microservice;
determining a delay in receiving the intermediate information from the first microservice;
generating a predicted response from the first microservice, the predicted response including predicted intermediate information;
applying the predicted intermediate information to a response process for determining the final response;
receiving an actual response from the first microservice, the actual response including actual intermediate information; and
taking a responsive action based on a comparison of the actual intermediate information and the predicted intermediate information.

2. The computer-implemented method of claim 1, further comprising:
returning a tentative response to the request for information based on the predicted intermediate information, the returning performed prior to receipt of the actual response.

3. The computer-implemented method of claim 1, further comprising:
determining, based on the comparison, the actual intermediate information is a mismatch with respect to the predicted intermediate information;
wherein:
taking the responsive action includes rolling back the response process to apply the actual intermediate response.

4. The computer-implemented method of claim 1, wherein the receiving the actual response is performed during the response process, prior to determining the final response.

5. The computer-implemented method of claim 1, further comprising:
determining, based on the comparison, the actual intermediate information is a mismatch with respect to the predicted intermediate information;
wherein:
taking the responsive action includes performing a distributed cancel to end ongoing processes relying on the predicted intermediate information.

6. The computer-implemented method of claim 1, further comprising:
ranking performance of a set of receiving microservices including the first microservice;
wherein determining the delay comprises:
identifying the first microservice as having a performance ranking below a threshold level.

7. The computer-implemented method of claim 1, wherein determining the delay and generating the predicted response is performed by a sidecar response predictor of an application receiving the request for information.

8. The computer-implemented method of claim 1, wherein determining the delay and generating the predicted response is performed by a sidecar response predictor of the first microservice.

9. The computer-implemented method of claim 1, further comprising:
maintaining, by a sidecar change propagator, a response cache containing previous responses from a set of receiving microservices including the first microservice;
wherein:
generating the predicted response is performed with reference to the response cache.

10. The computer-implemented method of claim 1, further comprising:
receiving the request for information from a client device.

11. A computer-implemented method comprising:
identifying a frequent request sent from a set of applications to a target microservice, the frequent request meeting a threshold number of times the frequent request was send to the target microservice;
automatically sending the frequent request at pre-defined periods to the target microservice;
determining an actual response to the frequent request does not match a stored response to the frequent request, the stored response being stored in a response cache of an application of the set of applications; and
updating the response cache and other response caches of the set of applications to replace the stored response with the actual response.

12. The computer-implemented method of claim 11, wherein identifying the frequent request includes:
recording information requests set from the set of applications to a plurality of microservices, including the target microservice, the recording including timestamps and content of requests;
determining the frequent request is sent a threshold number of times based on the recording; and
establishing the pre-defined periods for automatically sending the frequent request to the target microservice.

13. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
identifying a first microservice having intermediate information needed to create a final response to a request for information;
sending an intermediate request for the intermediate information to the first microservice;
determining a delay in receiving the intermediate information from the first microservice;
generating a predicted response from the first microservice, the predicted response including predicted intermediate information;
applying the predicted intermediate information to a response process for determining the final response;
receiving an actual response from the first microservice, the actual response including actual intermediate information; and
taking a responsive action based on a comparison of the actual intermediate information and the predicted intermediate information.

14. The computer system of claim 13, further causing the processor set to perform a method comprising:
returning a tentative response to the request for information based on the predicted intermediate information, the returning performed prior to receipt of the actual response.

15. The computer system of claim 13, further causing the processor set to perform a method comprising:
determining, based on the comparison, the actual intermediate information is a mismatch with respect to the predicted intermediate information;
wherein:
taking the responsive action includes rolling back the response process to apply the actual intermediate response.

16. The computer system of claim 13, further causing the processor set to perform a method comprising:
determining, based on the comparison, the actual intermediate information is a mismatch with respect to the predicted intermediate information;
wherein:
taking the responsive action includes performing a distributed cancel to end ongoing processes relying on the predicted intermediate information.

17. The computer system of claim 13, further causing the processor set to perform a method comprising:
ranking performance of a set of receiving microservices including the first microservice;
wherein determining the delay comprises:
identifying the first microservice as having a performance ranking below a threshold level.

18. The computer system of claim 13, wherein determining the delay and generating the predicted response is performed by a sidecar response predictor of an application receiving the request for information.

19. The computer system of claim 13, further causing the processor set to perform a method comprising:
maintaining, by a sidecar change propagator, a response cache containing previous responses from a set of receiving microservices including the first microservice;
wherein:
generating the predicted response is performed with reference to the response cache.
